(19) United States
(12) Patent Application Publication
(10) Pub. No.: US 2025/0078372 A1
(43) Pub. Date: Mar. 6, 2025

(54) INTERACTIVE ANIMATION PROCESSING

(71) Applicant: Tencent Technology (Shenzhen) Company Limited, Shenzhen (CN)

(72) Inventors: Min TAN, Shenzhen (CN); Qiuxiao LI, Shenzhen (CN)

(73) Assignee: Tencent Technology (Shenzhen) Company Limited, Shenzhen (CN)

(21) Appl. No.: 18/951,568

(22) Filed: Nov. 18, 2024

Related U.S. Application Data
(63) Continuation of application No. PCT/CN2023/125598, filed on Oct. 20, 2023.

(30) Foreign Application Priority Data
Nov. 29, 2022 (CN) 202211517742.2

(51) Int. Cl. G06T 13/00

(52) U.S. Cl. CPC G06T 13/00

(57) ABSTRACT

In an animation processing method, a first animation is displayed in a view interface. The first animation includes a first animation element having a first animation effect in the first animation. When a message that contains key content is displayed in the view interface during playback of the first animation, a second animation associated with the key content is displayed in the view interface. The second animation includes a second animation element. The first animation is updated when the second animation element interacts with the first animation element. The first animation element has a second animation effect in the updated first animation. Apparatus and non-transitory computer-readable storage medium counterpart embodiments are also contemplated.

### RELATED APPLICATIONS

The present application is a continuation of International Application No. PCT/CN2023/125598, filed on Oct. 20, 2023, which claims priority to Chinese Patent Application No. 202211517742.2, filed on Nov. 29, 2022. The entire disclosures of the prior applications are hereby incorporated by reference.

### FIELD OF THE TECHNOLOGY

This application relates to the field of computer technologies, including animation processing.

### BACKGROUND OF THE DISCLOSURE

With the development of Internet technologies, social functions provided by application programs (also referred to as clients) become increasingly rich. Playing an animation in a client is a related social manner, and a social atmosphere may be enhanced in some application scenarios. For example, in a chat scenario, when a chat object sends an emoji in a social chat, an animation associated with the emoji may be played in the social chat. For example, a cake emoji may drop when “happy birthday” is sent, and an explosion animation may be played when a bomb emoji is sent. The playing of these animations brings very interesting interactive experience. However, in the related art, an animation playing method in a social scenario is relatively fixed, has no high flexibility and poor interactivity, and the utilization of hardware resources of a device is low.

### SUMMARY

Embodiments of this disclosure provide an animation processing method, apparatus, and a non-transitory computer-readable storage medium to improve the flexibility of animation playing and the utilization of hardware resources of a device.

An aspect of this disclosure provides an animation processing method. A first animation is displayed in a view interface. The first animation includes a first animation element having a first animation effect in the first animation. When a message that contains key content is displayed in the view interface during playback of the first animation, a second animation associated with the key content is displayed in the view interface. The second animation includes a second animation element. The first animation is updated when the second animation element interacts with the first animation element. The first animation element has a second animation effect in the updated first animation.

An aspect of this disclosure provides an apparatus. The apparatus includes processing circuitry configured to display a first animation in a view interface. The first animation includes a first animation element having a first animation effect in the first animation. When a message that contains key content is displayed in the view interface during playback of the first animation, the processing circuitry is configured to display a second animation associated with the key content in the view interface. The second animation includes a second animation element. The processing circuitry is configured to update the first animation when the second animation element interacts with the first animation element. The first animation element has a second animation effect in the updated first animation.

An aspect of this disclosure provides a non-transitory computer-readable storage medium storing instructions which when executed by a processor cause the processor to perform any of the methods of this disclosure.

Embodiments of this disclosure can have the following beneficial effects:

In the embodiments of this disclosure, in a process of playing a first animation in a view interface, if a message containing key content appears in the view interface, it may further be triggered to play a second animation related to the key content in the view interface. As can be learned, the view interface supports simultaneous playing of two animations. This enriches animation playing manners in the view interface. In addition, the first animation includes a first animation element having a first animation effect, and the second animation includes a second animation element. When the second animation element acts on the first animation element, the first animation is updated, and an animation effect of the first animation element is changed (that is, changed from the first animation effect to a second animation effect). As can be learned, the playing of the second animation is triggered through the message containing the key content in the view interface, and the interaction is implemented between the second animation and the first animation through the action between animation elements. In this way, the interaction with a message in an animation playing process is implemented in the view interface. This is an innovative animation interaction manner. Through the interaction, the same animation element (the first animation element) has different animation effects before and after the first animation is updated. In this way, deep coupling between an animation and a message can be implemented, thereby improving the social interactivity. In addition, as long as the message containing the key content appears in the view interface, the first animation may be updated by changing an animation effect of the first animation element in the first animation. In this way, the animation effect included in the first animation can be adjusted flexibly, so that animation display forms are enriched, the playing of animations is more flexible, and the utilization of hardware processing resources and hardware display resources of a device are improved.

### BRIEF DESCRIPTION OF THE DRAWINGS

FIG. 1 is an architectural diagram of an animation processing system according to an embodiment of this disclosure.

FIG. 2 is a schematic flowchart of an animation processing method according to an embodiment of this disclosure.

FIG. 3A is a schematic diagram of a first animation according to an embodiment of this disclosure.

FIG. 3B is a schematic diagram of a second animation according to an embodiment of this disclosure.

FIG. 3C is a schematic diagram of updating a first animation according to an embodiment of this disclosure.

FIG. 4 is a schematic flowchart of an animation processing method according to an embodiment of this disclosure.

FIG. 5A is a schematic diagram of triggering a first animation according to an embodiment of this disclosure.

FIG. 5B is a schematic diagram of triggering a second animation according to an embodiment of this disclosure.

FIG. 5C is another schematic diagram of updating a first animation according to an embodiment of this disclosure.

FIG. 5D is another schematic diagram of updating a first animation according to an embodiment of this disclosure.

FIG. 5E is another schematic diagram of updating a first animation according to an embodiment of this disclosure.

FIG. 5F is another schematic diagram of updating a first animation according to an embodiment of this disclosure.

FIG. 6 is a schematic flowchart of an animation processing method according to an embodiment of this disclosure.

FIG. 7A is a schematic diagram of a second animation element acting on a second virtual character according to an embodiment of this disclosure.

FIG. 7B is a schematic diagram of displaying a virtual resource package according to an embodiment of this disclosure.

FIG. 7C is a schematic diagram of displaying a virtual resource package according to an embodiment of this disclosure.

FIG. 7D is a schematic diagram of displaying a virtual resource package according to an embodiment of this disclosure.

FIG. 7E is a schematic diagram of outputting prompt information according to an embodiment of this disclosure.

FIG. 8A is a schematic diagram of a resource collection interface according to an embodiment of this disclosure.

FIG. 8B is a schematic diagram of outputting a notification indicating that a second game group wins according to an embodiment of this disclosure.

FIG. 9 is a schematic structural diagram of an animation processing apparatus according to an embodiment of this disclosure.

FIG. 10 is a schematic structural diagram of a computer device according to an embodiment of this disclosure.

### DESCRIPTION OF EMBODIMENTS

The following describes the technical solutions in the embodiments of this disclosure with reference to the accompanying drawings in the embodiments of this disclosure. The described embodiments are some embodiments of this disclosure and not to be taken in an exhaustive sense. All other embodiments obtained by a person of ordinary skill in the art based on the embodiments of this disclosure fall within the scope of this disclosure.

In the following descriptions, related “some embodiments” describe a subset of all possible embodiments. However, the “some embodiments” may be the same subset or different subsets of all the possible embodiments, and may be combined with each other without conflict.

In the following descriptions, the related term “first, second, . . . ” is merely intended to distinguish between similar objects rather than represent a particular sequence of the objects. A particular sequence or a chronological order indicated by “first, second, . . . ” may be changed, so that the embodiments of this disclosure described herein can be implemented in a sequence other than the sequence illustrated or described herein.

To better understand the solutions in the embodiments of this disclosure, related terms and concepts that may be involved in the embodiments of this disclosure are described below first. The descriptions of the terms are provided as examples only and are not intended to limit the scope of the disclosure.

### 1. Social Interface:

A social interface is an interface configured to provide social interaction. The social interaction includes, but is not limited to, a social chat, content interaction, audio and video playing, and the like. Based on different types of social interaction, the social interface may include any one of the following: a chat interface of a social chat, a content interface of a content platform, a video playing interface, and the like. In the social interface, a message can be displayed, and an animation can be played.

### 2. Animation

An animation is a continuous picture formed by one or more animation elements. The animation element is a basic element, for example, a virtual character, a virtual scene, or a virtual item, that forms an animation. The animation may include an emoji animation, a scene animation, a virtual character animation, or the like. The emoji animation is, for example, a bomb emoji or a firework emoji. Different frames of the emoji animation may be different display content of the same animation element or different animation elements.

### 3. Animation Effect:

An animation effect is a moving display effect of an animation element in an animation. For example, if the animation is an animation of a firework emoji, an animation effect of the firework emoji is an effect of a firework being played on a screen. If the animation is a virtual character animation, an animation effect of the virtual character animation may be that a virtual character runs, walks, jumps, or the like.

An architecture of an animation processing system provided in embodiments of this disclosure is described below.

FIG. 1 is an architectural diagram of an animation processing system according to an embodiment of this disclosure. As shown in FIG. 1, the animation processing system includes a terminal device 101 and a server 102. A communication connection may be established between the terminal device 101 and the server 102 in a wired or wireless manner.

The terminal device 101 includes, but is not limited to, a smartphone, a tablet computer, a smart wearable device, a smart voice interaction device, a smart home appliance, a personal computer, an in-vehicle terminal, a smart camera, a virtual reality device (for example, VR or AR), and other devices. This is not limited in this disclosure. A quantity of terminal devices is not limited in this disclosure. The server 102 may be an independent physical server, or may be a server cluster or distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform, but is not limited thereto. A quantity of servers is not limited in this disclosure.

The terminal device 101 may run a client having a social interaction function. The client herein includes, but is not limited to, a social client, a game client, a live streaming client, an office client, and the like. The client may be any one of an independent application program, an installation-free program (for example, an applet), and a World Wide Web application program. The social interaction includes, but is not limited to, a chat, a message, a like, a comment, and the like. The client in the terminal device may display a view interface, and play a first animation in the view interface, the first animation including a first animation element, the first animation element having a first animation effect in the first animation.

In an implementation, the playing of the first animation may be triggered by the presence of a message containing target content in the view interface. The target content is, for example, a name of the first animation element or a name of a source game of the first animation element. In a process of playing the first animation, when a message containing key content appears in the view interface, a second animation may be played in the view interface. The key content is, for example, a name of a second animation element. It is supported that an animation element included in the second animation acts on the first animation element in the first animation. Along with the playing of the second animation, when the second animation element acts on the first animation element, the first animation may be updated. A first animation element in an updated first animation has a second animation effect, and the second animation effect is different from the first animation effect. The message containing the key content triggers the playing of the second animation, and the second animation element in the second animation acts on the first animation element to change an animation effect of the first animation element in the first animation being played. In this way, it can be implemented that the message actively interacts with the first animation, and the animation effect of an animation element is no longer fixed in the first animation. The first animation has more flexible and richer display forms in an interaction process.

The server 102 may provide backend service support for the client, including, but not limited to: transmitting animation trigger rules (including a first animation trigger rule and a second animation trigger rule, the first animation trigger rule including the target content, the second animation trigger rule including the key content) to the client through a network, forwarding chat messages sent by chat objects in a social chat, for example, the message containing the key content and the message containing the target content, and forwarding an animation update instruction to update an animation.

The animation processing method and the animation processing system provided in the embodiments of this disclosure may be used in various social scenarios, for example, a social chat scenario, a live streaming scenario, a game scenario, and an office scenario. In different social scenarios, the playing of different animations such as the first animation and the second animation is supported in the view interface. This enriches animation playing manners in the view interface. The interaction between different animations may be implemented through the action between animation elements. During the playing of the first animation, the playing of another animation may be triggered by the message containing the key content to update the first animation being played and change an animation effect of a corresponding animation element in the first animation. In this way, the interaction with a message in an animation playing process is implemented, and the interactivity between a message and an animation is improved, thereby improving the social interactivity. This innovative animation interaction manner can flexibly adjust an animation effect of an animation element in an animation, so that display forms of animations in a social scenario are enriched, and the playing flexibility is high.

In some embodiments, the view interface may be a social interface. When the animation processing system is used in a social chat scenario, the social interface is a chat interface of the social chat. After triggering the playing of the first animation in the social interface, any chat object in the social chat also plays the first animation in a social interface displayed on a side of another chat object in the social chat. In addition, the any chat object in the social chat may send the message containing the key content to trigger the second animation element to act on the first animation element, to change the first animation effect of the first animation element, for example, change a traveling speed. Therefore, intervention on an execution process and an execution result of the first animation is implemented. The client may transmit the updated first animation to the server, and the server transmits the updated first animation to another chat object in the social chat, so that animation content displayed in the chat interfaces of the chat objects is the same. In summary, the first animation may interact with a message in a playing process. In one aspect, this interaction breaks a conventional animation interaction manner, the playing of an animation may be triggered by a message, and in an animation playing process, the animation may also interact with the message to change an animation effect of an animation element, thereby achieving deep coupling between the animation and the message, and making the playing of the animation more flexible. In another aspect, this interaction is beneficial to improving the participation of the chat objects in the social chat. Any chat object can send the message containing the key content. Different chat objects can cooperate with each other to update the first animation repeatedly, thereby improving the social interactivity and fun.

Next, an animation processing method provided in embodiments of this disclosure is described below.

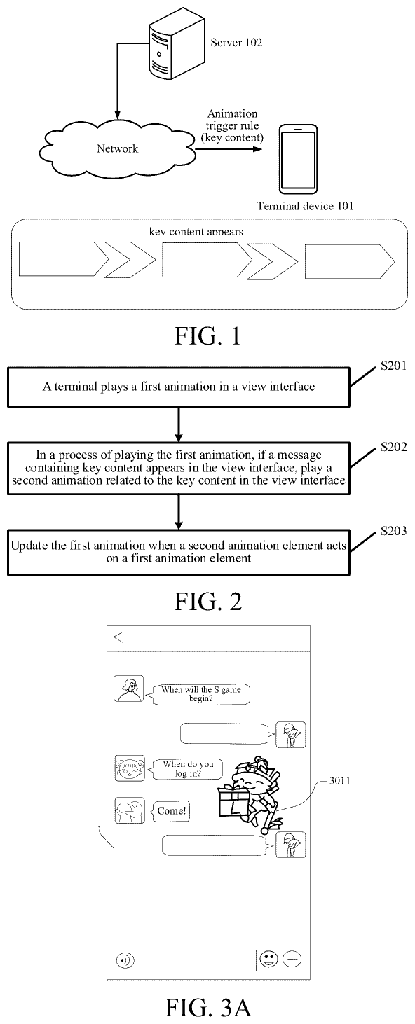

FIG. 2 is a schematic flowchart of an animation processing method according to an embodiment of this disclosure. In actual application, the animation processing method may be implemented by a terminal or a server alone, or by the terminal and the server in cooperation. An example in which the animation processing method is performed by a terminal device (for example, the terminal device 101 in FIG. 1) is used. A client having a social interaction function is run in the terminal device. The animation processing method may include the following content:

S201: A terminal plays a first animation in a view interface. For example, a first animation is displayed in a view interface. In an example, the first animation includes a first animation element having a first animation effect in the first animation.

The view interface may be a social interface, an audio/video playing interface having a social function, an interface of an educational client having a social function, or the like. The social interface may be an interactive interface provided by any application program. Social interaction is supported in the social interface. The social interaction includes, but is not limited to, a chat, a like, a comment, and a message. A terminal device may display a message in the social interface, or may play the first animation in the social interface. The first animation is any animation.

For example, the social interface may be a chat interface of a social chat. The social chat includes a personal chat or a group chat in an application supporting a social function. The chat interface of the social chat may be configured for displaying a chat message sent by a chat object or a message sent by a system. Triggering of the first animation may be implemented based on a specific chat message sent by a chat object. The specific chat message is a message containing target content. The target content is specified content, and may be preconfigured. In some embodiments, the target content is related to the first animation, for example, is associated with a first animation element in the first animation. For example, the target content is a name of the first animation element, or is a name of an animation element associated with the first animation element. For example, the first animation is a virtual character animation. In this case, the target content may be a name of a virtual character. To be specific, a chat message containing the name of the virtual character appears in the social interface, and the virtual character animation can be displayed in the social interface.

An animation element in the first animation is referred to as the first animation element. The first animation element may be an emoji, an image, a text, or the like. For example, the first animation element is a slipper, a flower, a steamship, or the like, or is a WordArt text, a virtual character, or the like. The first animation may include one first animation element, or may include a plurality of first animation elements.

The first animation element has a first animation effect in the first animation. The first animation effect is a moving display effect of the first animation element in the first animation. For example, the first animation element is a slipper, and the first animation effect of the first animation element in the first animation may be an animation effect of throwing a slipper along a specified path. In an implementation, because the first animation is played in the social interface, the first animation effect of the first animation element may be directly presented in the social interface.

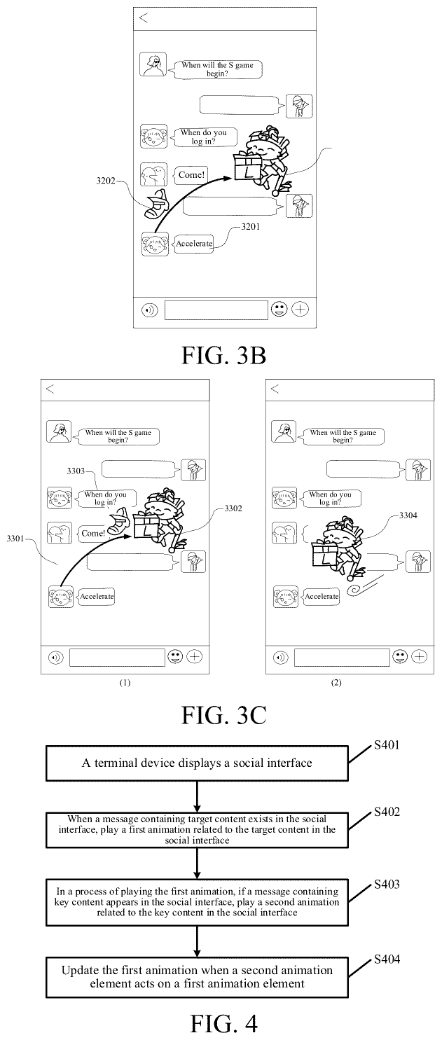

For example, FIG. 3A is a schematic diagram of a first animation. A first animation played in a social interface 301 is a virtual character animation. A first animation element included in the first animation is a virtual character A marked with 3011. A first animation effect that the first animation element has is an animation effect of the virtual character A running.

S202: In a process of playing the first animation, if a message containing key content appears in the view interface, play a second animation related to the key content in the view interface. For example, when a message that contains key content is displayed in the view interface during playback of the first animation, a second animation associated with the key content is displayed in the view interface. In an example, the second animation includes a second animation element.

The key content in the message is configured for triggering playing of another animation (for example, a second animation) different from the first animation in the view interface. One or more messages may be displayed in the view interface. When the view interface is the chat interface of the social chat, the message displayed in the view interface may be a chat message sent by a chat object of the social chat, or a message (for example, a notification message) sent by the system. If the message containing the key content appears in the view interface in the process of playing the first animation, the playing of the second animation related to the key content is triggered in the view interface. For example, the key content contained in the message is text content “Run, A!”. In this case, the second animation may be an animation of throwing an acceleration slipper at A. One or more messages containing the key content may exist in the view interface. Each time a message containing the key content appears in the view interface, one second animation related to the key content may be played. In an implementation, when any two messages containing the key content appear in the view interface simultaneously, two second animations may be simultaneously played in the view interface, and the two second animations are the same or different. In another implementation, if a plurality of messages containing the key content appear in the view interface, a plurality of second animations may be played in the view interface according to an order in which the messages containing the key content appear, to implement the triggering of the playing of the second animation by the message, and each second animation may act on the first animation.

An animation element in the second animation is referred to as a second animation element. The second animation may include one or more second animation elements. Each second animation element is associated with the key content in the message. The second animation element also has a corresponding animation effect in the second animation. The second animation element may be a shoe, a mushroom, a flower, or the like, or may be a virtual character, or the like, for example, a virtual person, or a virtual pet. The second animation element and the first animation element may be the same. To be specific, the same animation element may exist in different animations played in the view interface. Certainly, the second animation element and the first animation element may be different. In an implementation, the first animation and the second animation are different animations. For example, FIG. 3B is a schematic diagram of a second animation. A message 3201 containing key content in an interface of a social chat is “Accelerate”. At a display position of the message 3201, one slipper 3202 (i.e., the second animation element included in the second animation) is thrown out. Meanwhile, the playing of the first animation is kept. To be specific, a first animation element 3203 in the first animation is still moving.

In an implementation, the key content may indicate an animation element in the first animation on which the second animation element in the second animation is supposed to act. For example, in the example shown in FIG. 3B, a message containing key content may be “Accelerate A”. In this case, the key content “Accelerate A” is configured for indicating that the second animation element acts on a virtual character “A”. As can be learned from above, the first animation and the second animation may be played in the same view interface, the first animation and the second animation may interact with each other, and the interaction may be implemented through the action between the second animation element and the first animation element.

S203: Update the first animation when a second animation element acts on a first animation element. For example, the first animation is updated when the second animation element interacts with the first animation element. In an example, the first animation element has a second animation effect in the updated first animation.

It is determined that the second animation element acts on the first animation element when at least one of the following is met: (1) the second animation element and the first animation element overlap at a display position; (2) a distance between the second animation element and the first animation element is within a preset distance, to be specific, a distance between a display position of the second animation element and a display position of the first animation element is less than a preset distance threshold; (3) traveling directions of the first animation element and the second animation element are consistent, to be specific, the traveling direction of the second animation element is toward the first animation element; and (4) the traveling direction of the second animation element is toward the first animation element, and the distance between the display position of the second animation element and the display position of the first animation element is less than the preset distance threshold.

When the second animation element acts on the first animation element, the first animation effect that the first animation element in the first animation is changed, and the first animation effect of the first animation element is changed into a second animation effect, to update the first animation. To be specific, an updated first animation also includes the first animation element, the first animation element has the second animation effect in the updated first animation, and the first animation effect and the second animation effect are different. The playing of the second animation may be triggered by the message containing the key content, and the second animation element actively acts on the first animation element to change an animation effect of the first animation element. Therefore, the interaction with a message in an animation playing process is implemented in the view interface.

For example, FIG. 3C is a schematic diagram of updating a first animation. In a view interface 3301, a first animation element is a virtual character A marked by 3302, and a second animation element is an acceleration slipper 3303. When the acceleration slipper 3303 is displayed near the virtual character A, an acceleration animation effect 3304 (i.e., the second animation effect) is presented for the virtual character A in the first animation. In this way, a traveling speed in an updated second animation effect is different from a traveling speed corresponding to the first animation effect.

The embodiments of this disclosure are described by using an example in which a second animation element of a second animation acts on a first animation. If a plurality of second animations is included, a second animation element in each second animation may act on the first animation element in the first animation, and the first animation may be updated once or a plurality of times by simultaneously superimposing or sequentially superimposing the plurality of second animation elements, so that the first animation achieves a richer animation effect under the action of the second animation. In some embodiments, a quantity of times of updating the first animation may correspond to a quantity of second animations. For example, a virtual character in the first animation may be accelerated a plurality of times or accelerated many times by superimposing a plurality of acceleration effects.

In the animation processing method provided in the embodiments of this disclosure, for a first animation played in a view interface, when a message containing key content appears in the view interface, a second animation related to the key content may be played. The second animation may be further played in a process of playing the first animation. Simultaneous playing of two animations is supported in the view interface, so that an animation playing manner in the view interface can be enriched. When a second animation element in the second animation acts on a first animation element of the first animation, the first animation may be updated, and a first animation effect of the first animation is changed into a second animation effect. In this way, in the process of playing the first animation, the first animation may interact with the message containing the key content. To be specific, another animation (for example, the second animation) is triggered through the message containing the key content. The another animation acts on the first animation, to flexibly change an animation effect of an animation element in the process of playing the first animation. In this way, the interaction with a message in an animation playing process is implemented in the view interface, so that while the fun of playing an animation in the view interface is improved and the social interactivity is improved, the utilization of hardware processing resources and hardware display resources of a device are improved.

FIG. 4 is a schematic flowchart of another animation processing method according to an embodiment of this disclosure. In actual application, the animation processing method may be implemented by a terminal or a server alone, or by the terminal and the server in cooperation. An example in which the animation processing method may be performed by a terminal device (for example, the terminal device 101 in FIG. 1) and a view interface is a social interface is used. A client having a social interaction function is run in the terminal device. The animation processing method may include the following content:

S401: A terminal device displays a social interface.

The terminal device may display the social interface in a client. The client herein may include, but not limited to, a social client dedicated to socializing, or another client having a social function, for example, a game client, a live streaming client, or an office client. The social interface may be a chat interface. The chat interface may allow at least two chat objects to have a message chat. The chat interface may be configured to display messages and play various animations. For example, an emoji animation may be played in the social interface. The emoji animation is an animation associated with an emoji element. For example, for a firework emoji, the emoji animation is correspondingly a firework playing animation. One or more messages exist in the social interface. In the one or more messages, a message containing target content may exist, or a message containing target content may not exist. When the social interface is a chat interface of a social chat, the message containing the target content may be a chat message sent by a chat object, or a notification message sent automatically by a system to the social interface.

S402: When a message containing target content exists in the social interface, play a first animation related to the target content in the social interface. For example, when a message that contains target content is displayed in the view interface, the first animation is displayed in the view interface.

Each time a message is added to the social interface, the client may detect whether the message contains the target content. The target content is content configured for triggering an animation, and the target content may be manually specified or specified in various manners by the system. When it is detected that the message contains the target content, it may be considered that a message containing the target content exists in the social interface, to further trigger the playing of the first animation. In an implementation, the target content is associated with the first animation, and animations associated with different target content are different or the same. In an implementation, the target content includes at least one of the following: an identifier of the first animation, an identifier of a first animation element included in the first animation, an identifier of a source of the first animation, and content associated with the first animation.

The identifier of the first animation may be a name of the first animation, an identifier of any animation element in the first animation, or the like. The identifier of the first animation element may be a name of the first animation element, a thumbnail of the first animation element, or the like. If the animation element in the first animation or the first animation comes from a game, the target content may include an identifier of a source game of the first animation. For example, the target content may be a game name, a game logo, a name of a game team, or the like. The content associated with the first animation may be another animation element in the first animation, an identifier of another animation element, or the like.

A display form of the target content in the message containing the target content includes at least one of the following: a text, an emoji, an image, and a speech. The message containing the target content may be referred to as a specific message or a target message. The target content is presented in the specific message in any display form or a combination of a plurality of display forms. For example, the target content is the first animation element (in an image form) in the first animation, or the name (in a text form or a speech form) of the first animation element. For example, the target content is a specified game keyword, for example, a game name or a person name in a game. In this way, the played first animation is an animation produced based on a virtual character in the game.

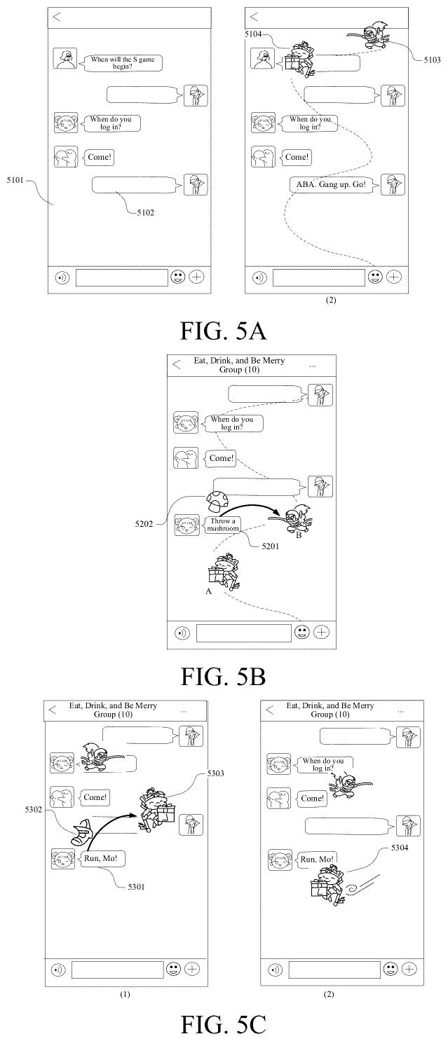

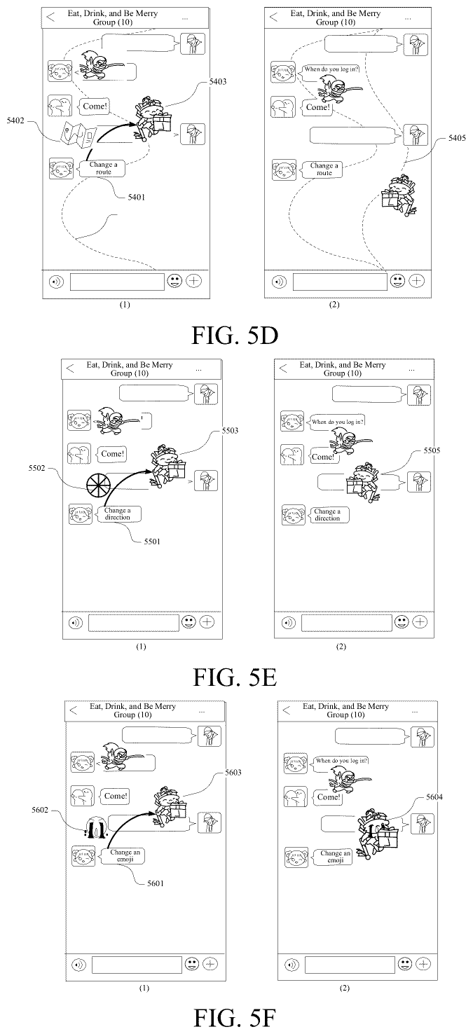

For example, FIG. 5A is a schematic diagram of triggering a first animation. As shown in (1) in FIG. 5A, a social interface 5101 is a chat interface of a social chat. A message 5102 containing a game name exists in the social interface 5101: “ABA. Gang up. Go!” After the social interface 5101 appears in the message 5102, a first animation of a virtual game character 5103 chasing a virtual character 5104 along a preset route may be played in the social interface, as shown in (2) in FIG. 5A.

The playing of the first animation in the social interface is triggered through the target content, and the target content has a plurality of display forms and various content. In this way, it is very convenient to start the first animation in a social interaction process, and the target content is carried in a message. In application to a social chat, the first animation may be triggered through the message containing the target content, so that more interaction experience can be brought to a chat object in a chat process.

S403: In a process of playing the first animation, if a message containing key content appears in the social interface, play a second animation related to the key content in the social interface. For example, when a message that contains key content is displayed in the view interface during playback of the first animation, a second animation associated with the key content is displayed in the view interface. In an example, the second animation includes a second animation element.

The playing of the first animation and the addition of a message to the social interface are independent. Therefore, in the process of playing the first animation, at least one message may be added to the social interface. To be specific, the playing of the first animation does not affect a chat of the chat object, and a message containing key content may exist in the message added to the social interface. The key content is configured for triggering the playing of content of the second animation. The key content may be preconfigured. The second animation may be any animation other than the first animation. The key content and the target content discussed above may be the same or may be different. When the client detects that a message contains the key content, the message containing the key content appears in the social interface. Each time a message containing the key content appears, the playing of the second animation related to the key content may be triggered. The appearance of different messages containing the key content may trigger the playing of different second animations. In this way, in the process of playing the first animation, a plurality of second animations may be played, and key content related to the second animations may be the same or different, so that the playing of the second animation becomes more diversified, and the action on the first animation is richer. The second animation includes a second animation element, and the second animation element and the first animation element may be different. In an implementation, the key content includes, but not limited to, at least one of the following: an identifier of the second animation, an identifier of the second animation element included in the second animation, an identifier of a source of the second animation, and content associated with the second animation.

The identifier of the second animation may be a name of the second animation, an identifier (for example, a name) of any animation element in the second animation, or the like. The identifier of the second animation element may be a name of the second animation element, a thumbnail of the second animation element, or the like. In actual application, the second animation or an animation element in the second animation may come from a game, a video, a live stream, or the like. If the animation element in the second animation or the second animation comes from a game, the target content may be a game name, a game logo, a game team name, a game skill word, or the like of the source game. The content associated with the second animation may be another animation element in the second animation, an identifier of another animation element, a skill word of the first animation element, or the like.

A display form of the key content in the message containing the key content includes at least one of the following: a text, an emoji, an image, and a speech. Any foregoing key content may be presented in one display form or a combination of a plurality of display forms. The key content may be content (for example, some delivered preset words, or preset images) delivered by a server to the client. For example, the key content is a game name. In this case, the message containing the key content may be a speech message or a text message. If the message is a speech message, it may be analyzed through a speech recognition technique whether the speech message contains a pronunciation of the game name. For example, FIG. 5B is a schematic diagram of triggering a second animation. A social interface is a chat interface of a social chat. A first animation is played in the social interface. The first animation is an animation of a virtual character B chasing a virtual character A along a preset route. A message 5201 containing a name of a second animation element is added to the social interface: “Throw a mushroom”. In this case, a second animation of throwing a mushroom 5202 (i.e., the second animation element) may be played in the social interface.

As can be learned, the playing of the second animation in the social interface is triggered through the key content, and the key content may be carried in a message. In this way, the interaction between the message and the second animation can be implemented, and various key content that can trigger the second animation and various display forms are provided, so that the second animation can be triggered more conveniently.

In an embodiment, the playing a second animation related to the key content in the social interface includes: acquiring a display position of a message containing the key content in the social interface, and playing the second animation related to the key content with the display position as a display start position of the second animation element in the second animation.

For case of description, the message containing the key content may be referred to as a key message for short. A display position of the key message in the social interface is used as the display start position of the second animation element in the second animation. In this case, during the playing of the second animation, the second animation element included in the second animation is presented starting from the display position. For example, the “mushroom” element 5202 in the second animation shown in FIG. 5B in the foregoing example is thrown from a display position of the message 5201. In this way, the interaction between the second animation element in the second animation and the message containing the key content is more intuitive and vivid, so that while hardware display resources of a device are fully utilized and the fun of animations are improved, the utilization of the hardware display resources of the device is further improved.

At least one (for example, at least two) message containing the key content may exist in the social chat. Different messages contain the same or different key content. However, because display positions of messages in the social interface are different, second animations associated with key content in the messages are independent. Therefore, second animations related to the key content may be played in the social interface according to a sequential order in which the messages are sent. For example, at least two key messages exist in the social interface, and respectively contain key content “Throw a mushroom” and “Throw a shoe”. In this case, an animation of throwing a mushroom and an animation of throwing a shoe from corresponding display positions may be played in the social interface.

In an implementation, the social interface is displayed in the client, and an animation rendering engine is built in the client. Based on the animation rendering engine, the second animation related to the key content may be played in the following manner: transmitting the display position of the message containing the key content in the social interface to the animation rendering engine; and invoking the animation rendering engine to play the second animation, and rendering the second animation element by using the display position of the message containing the key content in the social interface as the display start position in a process of playing the second animation.

The animation rendering engine is an engine, for example, a unity engine, configured for rendering an animation element in an animation and an animation effect of the animation element in the animation. The animation rendering engine may be built in the client, and is invoked to render an animation when the client has an animation rendering requirement. In an implementation, content drawn by the animation rendering engine may cover an entire social interface, but neither responds to an operation nor blocks an operation on the social interface. In this way, operation propagation, for example, tap propagation, is implemented. The animation rendering engine may render the first animation and the second animation, for example, a virtual character animation, a skill casting animation, and a gift animation.

The animation rendering engine may establish communication with the client to acquire an animation execution position from the client. The second animation related to the key content is played in the social interface. The client may invoke an interface view (for example, a chat view) to transmit the display position of the message containing the key content in the social interface to the animation rendering engine. The display position may be used as a start position of executing the second animation, so that the animation rendering engine may be invoked to use the display position as the display start position of the second animation element to render the second animation element and play the second animation. In this way, the second animation can be triggered from the display position of the message containing the key content. The rendering of the second animation element may be performed in real time in the process of playing the second animation, or the second animation may be directly played after the entire second animation has been rendered.

S404: Update the first animation when a second animation element acts on a first animation element. For example, the first animation is updated when the second animation element interacts with the first animation element. In an example, the first animation element has a second animation effect in the updated first animation.

For a manner of determining that the second animation element acts on the first animation element, refer to the foregoing manner. Details are not described herein again.

In a process of playing a corresponding animation in the social interface, the animation element in the animation is displayed moving. For example, the second animation element moves in the social interface along a preset route. Display positions of the second animation element and the first animation element in the social interface change with time. The display positions of the first animation element and the second animation element in the social interface are the same or different at any moment. In a manner, when animation elements in two animations are located at the same display position in the social interface at a moment, in other words, the display position of the first animation element and the display position of the second animation element overlap. A distance between the display positions of the two animation elements is zero, and it may be considered that the second animation element acts on the first animation element. In another manner, when the display positions of the first animation element and the second animation element are different, a distance between the display positions of the two animation elements may be determined. If the distance is less than a preset distance threshold, it may be considered that the second animation element acts on the first animation element. If the distance is greater than or equal to the preset distance threshold, it may be considered that the second animation element does not act on the first animation element. The preset distance threshold may be a manually set empirical value. The distance between the display positions of the two animation elements can intuitively and vividly represent whether the second animation element acts on the first animation element.

A traveling direction of the second animation element may be understood as a movement direction of the second animation element in the social interface. In the process of playing the second animation, the traveling direction of the second animation element may be any direction. For example, the traveling direction is a vertical direction or a horizontal direction relative to the social interface. In a manner, it may be determined whether the traveling direction of the second animation element is toward the first animation element, to further determine whether the second animation element acts on the first animation element. For example, if the traveling direction of the second animation element is toward the first animation element, the second animation element has a tendency to act on the first animation element, and it may be considered that the second animation element acts on the first animation element. If the traveling direction of the second animation element is not toward the first animation element, it is considered that the second animation element does not act on the first animation element. Through the traveling direction, a time taken to determine whether the second animation element acts on the first animation element can be reduced, so that the interaction between animations is more efficient. To perform determination more accurately, in addition to the traveling direction, other factors may further be combined. Whether the distance between the second animation element and the first animation element is less than the preset distance threshold is used to represent whether the second animation element acts on the first animation element.

The first animation element has the second animation effect in an updated first animation, and the second animation effect is different from a first animation effect. For example, the message containing the target content is “happy birthday” entered in the social interface. In this case, the first animation is an animation effect of a cake emoji dropping from the top of the social interface. Before the cake emoji drops and the animation ends, the first animation may interact with the message in the social interface. For example, a firework animation (which belongs to the message containing the key content) is added to the social interface. The second animation of a firework going off is played in the social interface. In this case, the cake emoji may present an animation effect (which belongs to the updated first animation) of being bounced off as the firework goes off.

At this point, the message containing the key content triggers the playing of the second animation, and the second animation element in the second animation interacts with the first animation, so that an animation effect of the first animation element in the first animation is updated through the interaction between the message and the first animation. When the social interface includes a plurality of messages containing the key content, through the cooperation of the messages, the first animation element in the first animation is updated a plurality of times. In application to a social chat scenario, messages containing the key content sent by different chat objects form a context, and act on the first animation. The chat objects may cooperate with each other to update the first animation, thereby improving the participation of the chat objects in the interaction.

In some embodiments, the first animation may include one or more (at least two) animation elements. Different animation elements may have different animation effects. The first animation element is any animation element in the first animation. The first animation element may have different animation effects in the first animation. In other words, the first animation element may have two or more animation effects in the first animation. The first animation element includes a first virtual character. If the first animation includes a plurality of virtual characters, the first virtual character is any virtual character of the plurality of virtual characters. Based on different first animation effects of the first virtual character in the first animation, when the second animation element acts on the first animation element, a manner of updating the first animation may include, but not limited to, four manners respectively described in (1) to (4) as follows:

(1) The first animation effect of the first virtual character in the first animation includes traveling according to a first speed. The second animation element includes an animation element configured for indicating to adjust a speed.

In actual application, the first virtual character is a multi-dimensional (for example, two-dimensional or three-dimensional) virtual character. The virtual character is, for example, a virtual person image, a virtual animal, or a virtual plant. The first animation includes animation content of the first virtual character traveling according to the first speed. The first speed may be a traveling speed set by default. The first speed may be adjusted under the action of the second animation element. The second animation element may be configured for adjusting the traveling speed of the first virtual character. The speed adjustment indicated by the second animation element may be acceleration or deceleration. To be specific, the second animation element may indicate to increase or reduce the traveling speed of the first virtual character.

An implementation of S404 includes: when the second animation element acts on the first virtual character, changing the traveling speed of the first virtual character according to the indication of the second animation element to update the first animation. To be specific, according to the indication of the second animation element, the traveling speed of the first virtual character is changed (increased or reduced), to implement the update of the first animation. The second animation effect of the first virtual character in an updated first animation includes: traveling according to a second speed, the second speed being different from the first speed, if the second animation element indicates acceleration, the second speed being greater than the first speed, if the first animation element indicates deceleration, the second speed being less than the first speed.

For example, when the second animation element acts on the first virtual character, for example, the display position of the second animation element and the display position of the first virtual character overlap, the client may adjust the traveling speed of the first virtual character from the first speed to the second speed according to the indication of the second animation element, to update the first animation. The first animation element has the second animation effect of traveling according to the second speed in the updated first animation. If the second animation element indicates acceleration, during the adjustment of the traveling speed of the first virtual character, the first speed of the first virtual character is increased to obtain the second speed, the second speed is greater than the first speed, and the first virtual character may travel according to the second speed. If the second animation element indicates deceleration, during the adjustment of the traveling speed of the first virtual character, the first speed of the first virtual character is reduced to obtain the second speed, and the second speed is less than the first speed.

As can be learned, the playing of the second animation is triggered based on the message containing the key content, the second animation element in the second animation may act on the first animation element in the first animation being displayed, and the traveling speed of the first animation element may be changed under the action of the second animation element. In this way, a gain effect (for example, acceleration) or an attenuation effect (for example, deceleration) may be added to the first animation element in the first animation through the message containing the key content. The first animation may be ended in advance or may be ended after a delay through the change in the traveling speed of the first animation element. In this way, an execution progress and an execution result of the first animation element may be intervened, thereby improving interaction experience.

For example, FIG. 5C is a schematic diagram of updating a first animation. The social interface is a chat interface (i.e., including three or more chat objects) of a group chat. The first animation element is a virtual character. A name of the virtual character is Mo. As shown in (1) in FIG. 5C, when a chat object sends a message 5301 containing key content: “Run, Mo!”, a pair of dash shoes 5302 (i.e., the second animation element) may be thrown at the virtual character Mo from a bubble of the message. After being hit, the virtual character Mo 5303 may obtain a dash skill to present a dash animation. An updated first animation is shown in (2) in FIG. 5C, and different animation effects 5304 appear around the virtual character Mo in the social interface.

In an implementation, the first virtual character may travel within a preset duration according to the second speed. When the preset duration is reached, the second speed of the first virtual character is automatically adjusted to the first speed, and the first virtual character travels according to the first speed. For example, the first speed is increased to obtain the second speed, the first virtual character may travel three seconds according to the second speed, and when an acceleration time of three seconds is reached, the first virtual character travels according to the first speed again. Although the traveling speed is restored to the original speed, the execution progress of the first animation is still changed. For example, the first animation is played for 10 seconds originally. After the traveling speed of the virtual character is changed, a playing duration may be reduced to 5 seconds. With the preset duration, the second animation effect of the first virtual character in the first animation may last a period of time.

A use duration of the traveling of the first virtual character according to the second speed may be not limited. In the process of playing the first animation, the first virtual character may travel according to the second speed before a change of the second speed of the first virtual character is initiated a next time. If a new second animation configured for indicating to adjust a speed exists, the second speed may be used as a traveling speed to be changed. In other words, the second speed is increased or reduced. In addition, when the second animation element does not act on the first virtual character, the first animation element in the first animation may keep traveling according to the first speed, or the traveling at the first speed is adjusted according to a traveling rule set in the system until the execution of the first animation ends.

In some embodiments, the traveling rule is configured for indicating positions and speeds of the first animation element at time points during traveling. In other words, the traveling rule can indicate a traveling route of the first animation element and speeds at positions on the traveling route.

(2) The first animation effect of the first virtual character in the first animation includes traveling along a first route. The second animation element includes an animation element configured for indicating to adjust a route. In other words, the second animation element can be configured for adjusting the traveling route of the first virtual character.

In some embodiments, an implementation of S404 may include: when the second animation element acts on the first virtual character, updating the first animation by changing the traveling route of the first virtual character according to the indication of the second animation element, the second animation effect of the first virtual character in the updated first animation including traveling along a second route, the first route being different from the second route.

In the process of playing the first animation, the first virtual character included in the first animation travels along the first route. The first route is a route along which a virtual character moves in the social interface, and the first route may be one of a plurality of pre-generated traveling routes. For example, the first route is the shortest or longest one of the plurality of traveling routes, or the first route is one selected in various manners from the plurality of traveling routes.

The virtual character travels based on a corresponding traveling route, so that the animation effect of the first animation is more natural and vivid. When the second animation element acts on the first virtual character, the traveling route of the first virtual character may be changed from the first route to the second route according to the indication of the second animation element to update the first animation, and the first virtual character in the updated first animation travels along the second route. The second route may be one selected in various manners from other traveling routes other than the first route in the plurality of pre-generated traveling routes, or may be one traveling route specified by the second animation element.

For example, FIG. 5D is a schematic diagram of updating a first animation. A social interface is a chat interface of a social chat, as shown in (1) in FIG. 5D. When a message 5401 sent by a chat object contains “Change a route”, a map 5402 may be thrown at a virtual character from a bubble of the message to change a current traveling route 5404 of a virtual character 5403 into a route 5405. An updated first animation is shown in (2) in FIG. 5B. A first virtual character travels along the route 5405 in the updated first animation.

The first route and the second route may be two routes that have an intersection, or may be two routes that have no intersection. After the traveling route of the first virtual character is changed into the second route, a position closest to a current display position of the first virtual character may be determined in the second route, and the first virtual character starts to travel from the position, for example, the position of the intersection of the two routes.

(3) The first animation effect of the first virtual character in the first animation includes traveling according to a first direction. The second animation element includes an animation element configured for indicating to adjust a direction. In other words, the second animation element can be configured for indicating to adjust a traveling direction of the first virtual character.

In some embodiments, an implementation of S404 includes: when the second animation element acts on the first virtual character, updating the first animation by changing the traveling direction of the first virtual character, for example, adjusting the traveling direction of the first virtual character from the first direction to a second direction according to the indication of the second animation element, the second animation effect of the first virtual character in the updated first animation including traveling according to the second direction, the first direction being different from the second direction. For example, the first direction is a vertical direction relative to the social interface, and the second direction is a horizontal direction relative to the social interface. The first virtual character in the updated first animation travels according to the second direction.

For example, FIG. 5E is a schematic diagram of updating a first animation. A social interface is a chat interface of a social chat, as shown in (1) in FIG. 5E. When a message 5501 sent by a chat object contains a keyword “Change a direction”, a compass 5502 may be thrown at a virtual character from a bubble of the message to adjust a current direction of traveling to the right of a virtual character 5503 into a direction of traveling to the left. An updated first animation is shown in (2) in FIG. 5E. A first virtual character 5505 continues to travel to the left in the updated first animation. In this way, the traveling direction of the first animation element in the first animation may be flexibly changed under the action of the second animation element. In this way, more diversified interaction between different animation elements is provided, so that action forms between the first animation and the message are enriched.

(4) The first animation effect of the first virtual character in the first animation includes displaying in a first display manner. The second animation includes an animation element configured for indicating to adjust a display manner. In other words, the second animation can be configured for indicating to adjust a display manner of the first virtual character.

In some embodiments, an implementation of S404 includes: when the second animation element acts on the first virtual character, updating the first animation by changing the display manner of the first virtual character, for example, switching the display manner of the first virtual character from the first display manner to a second display manner, the second animation effect of the first virtual character in the updated first animation including displaying in the second display manner, the second display manner being different from the first display manner.

The first virtual character in the first animation is displayed in the first display manner. The first display manner may be a default display manner set for the first virtual character. For example, the first virtual character is displayed according to a default size and a default action. The default action is, for example, any action of running, crossing, or walking of the virtual character.

The second animation element is an animation element configured for indicating to adjust a display manner. For example, the second animation element is a magnifying glass. When the second animation element acts on the first virtual character, the display manner of the first virtual character may be changed from the first display manner to the second display manner. The second display manner is any display manner different from the first display manner. After the display manner is changed, the update of the first animation is completed, and the first virtual character in the updated first animation is displayed according to the second display manner.

The display manner including any one of the following: displaying with an increased size, displaying with a reduced size, displaying a specific emoji, and displaying a designated action. The second display manner may be any foregoing display manner. If the second display manner is displaying with an increased/reduced size, the first virtual character may be displayed with an increased/reduced size in the updated first animation. For example, an avatar of the first virtual character is displayed with an increased size. If the second display manner indicates to display a specific emoji, a face emoji of the first virtual character may be changed to a specific emoji. The specific emoji may be a preset emoji, for example, a forced smile emoji, or a cry emoji. For example, a smile emoji of the first virtual character may be changed to a laugh emoji, to change the display manner of the first virtual character. If the second display manner indicates to display a specific action, a limb action of the first virtual character may be changed to a specified action. The specified action is an action, for example, a jump, a throw, or a jump back kick, specified for the first virtual character. The action of the first virtual character may be obtained by capturing an action of a person in reality, or is generated based on an action configuration parameter. The action configuration parameter includes an action extent parameter, a posture parameter, and the like.

For example, FIG. 5F is a schematic diagram of updating a first animation. A social interface is a chat interface of a social chat, as shown in (1) in FIG. 5F. When a message 5601 sent by a chat object contains a keyword “Change an emoji”, a cry emoji 5602 may be thrown at a virtual character from a bubble of the message. When the emoji 5602 hits a virtual character 5603, a smile emoji of the virtual character 5603 may be changed to the cry emoji. An updated first animation is shown in (2) in FIG. 5F. A face emoji of a first virtual character 5604 in the updated first animation is the cry emoji.

In this way, under the action of the second animation element on the first animation element in the first animation, the display manner of the first animation element in the first animation may be changed. Based on the action of the second animation element on the first animation element, the change of the display manner of the first animation element is triggered, so that the utilization of hardware processing resources and hardware display resources are improved, and the fun of playing the first animation in a playing process can be improved by changing the display manner.

In the animation processing method provided in the embodiments of this disclosure, a first animation may be triggered by a message containing target content and played in a social interface, and in a process of playing the first animation, a second animation may be triggered by a message (referred to as a key message for short) containing key content and displayed in the social interface. Messages containing different content may trigger simultaneous playing of different animations in the same social interface, animation playing manners in the social interface can be enriched. The second animation may be rendered by an animation rendering engine based on a display position of an obtained key message, to achieve the effect of displaying a second animation element from the display position, thereby improving the interactivity between a message and an animation. When a first animation element is a first virtual character, a plurality of first animation effects of the first animation element in the first animation are included, and include, but not limited to: traveling according to a first speed, traveling along a first route, traveling according to a first direction, and displaying according to a first display manner. These first animation effects are animation effects in different dimensions. The second animation element is configured for indicating to adjust a first animation effect of the first animation element. When the second animation element acts on the first animation element, an animation effect of the first animation element in the first animation may be changed. Based on the action of different second animation elements, the change of the first animation element has different dimensions. In this way, interaction forms with the first animation are enriched, so that while the fun and flexibility of animation playing are improved, the utilization of hardware processing resources and hardware display resources of a device are improved.

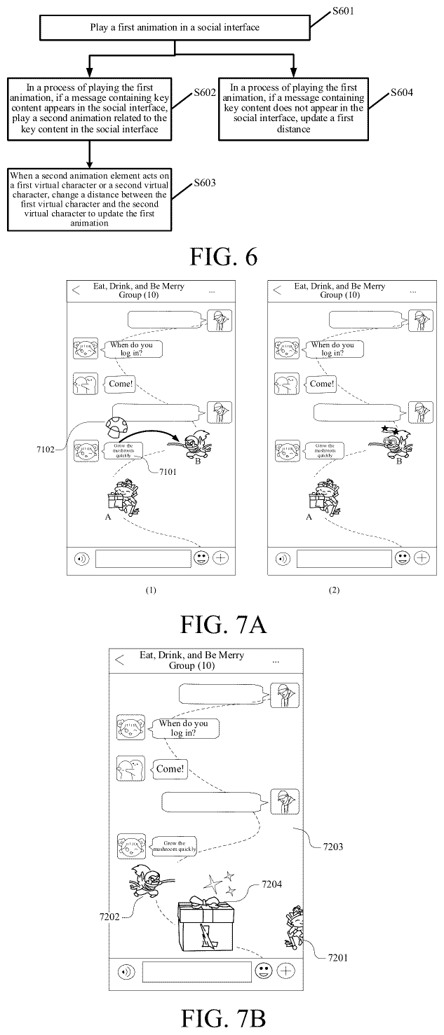

FIG. 6 is a schematic flowchart of another animation processing method according to another embodiment of this disclosure. In actual application, the animation processing method is implemented by a terminal or a server alone, or by the terminal and the server in cooperation. An example in which the animation processing method may be performed by a terminal device (for example, the terminal device 101 in FIG. 1) and a view interface is a social interface is used. A client having a social interaction function is run in the terminal device. The animation processing method may include the following content:

S601: Play a first animation in a social interface. For example, a first animation is displayed in a view interface. In an example, the first animation includes a first animation element having a first animation effect in the first animation.

S602: In a process of playing the first animation, if a message containing key content appears in the social interface, play a second animation related to the key content in the social interface. For example, when a message that contains key content is displayed in the view interface during playback of the first animation, a second animation associated with the key content is displayed in the view interface. In an example, the second animation includes a second animation element.

The first animation includes a first animation element. The first animation element includes a first virtual character and a second virtual character. A first animation effect of the first animation element in the first animation includes: a first distance exists between the second virtual character and the first virtual character, and the second virtual character chases the first virtual character along a preset route. The first virtual character and the second virtual character are different virtual characters. The first distance between the first virtual character and the second virtual character may be a linear distance or a nonlinear distance between different display positions of the two virtual characters in the social interface. For example, the schematic diagram of the first animation shown in FIG. 5A above includes two virtual characters, the two virtual characters have different display positions in the social interface, and one virtual character chases the other virtual character.

Based on the content included in the first animation element and the first animation effect that the first animation element has in the first animation described above, when the second animation element acts on the first animation element, an implementation of updating the first animation may be the content described in S603 and S604 below.

S603: When a second animation element acts on a first virtual character or a second virtual character, change a distance between the first virtual character and the second virtual character to update the first animation. For example, the first distance between the first virtual character and the second virtual character is modified when the second animation element interacts with either the first virtual character or the second virtual character. In an example, the second animation effect includes the second virtual character chasing the first virtual character while maintaining a second distance between the second virtual character and the first virtual character.

The second animation element is an animation element configured for adjusting a distance between different virtual characters. A distance between two virtual characters may be changed when the second animation element acts on any virtual character (for example, the first virtual character or the second virtual character) included in the first animation element. For example, the first distance is changed to the second distance to update the first animation. A second animation effect of the first animation element in an updated first animation includes: a second distance exists between the second virtual character and the first virtual character, and the second virtual character chases the first virtual character. The second distance and the first distance are different distances. The first distance may be greater than the second distance, or the first distance may be less than the second distance. This depends on whether a distance adjustment direction indicated by the second animation element is increase or reduction.

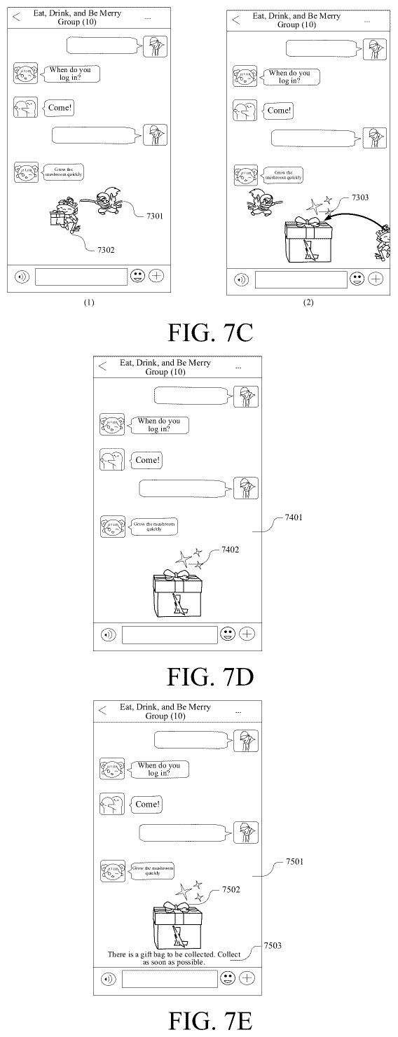

For example, FIG. 7A is a schematic diagram of a second animation element acting on a second virtual character. A social interface is a chat interface of a social chat, as shown in (1) in FIG. 7A. A first animation element includes a virtual character A and a virtual character B. A message 7101 sent by a chat object is “Grow the mushroom quickly”. A mushroom element 7202 may be displayed. When the mushroom acts on the virtual character B, a first animation is updated. An updated first animation is shown in (2) in FIG. 7A. The virtual character B presents an animation effect of dizziness in the first animation.

In a manner, the distance between the two virtual characters may be changed by adjusting any one of a traveling speed, a traveling direction, and a traveling route of any virtual character. For example, if the second animation element acts on the first virtual character to increase a traveling speed of the first virtual character and a traveling speed of the second virtual character remains unchanged, the distance between the first virtual character and the second virtual character may be increased, and the second distance obtained by changing the distance is greater than the first distance. In contrast, if the traveling speed of the second virtual character is increased and the traveling speed of the first virtual character remains unchanged, the distance between the first virtual character and the second virtual character may be reduced, and the second distance obtained by changing the distance is less than the first distance.

In an embodiment, the second virtual character chases the first virtual character along the preset route, the first virtual character and the second virtual character travel along the same route, and the first distance or the second distance between the two virtual characters is a distance between the virtual characters at different positions of the preset route. A manner of determining the preset route may include: determining a route start position and a route end position in the social interface; generating one or more routes according to a route generation rule, different routes having the same route start position and route end position; and selecting one route from the one or more routes as the preset route.

For example, the route start position and the route end position are different positions in the social interface. The route start position and the route end position may be preset. In some embodiments, a linear distance between the route start position and the route end position needs to be greater than or equal to a distance threshold. For example, after a point is selected in various manners from the social interface as the route start position, another point with a linear distance from the route start position being greater than the distance threshold is selected in various manners from the social interface as the route end position. In some embodiments, a point may be selected in various manners in a top region of the social interface as the route start position, and a point is selected in various manners in a bottom region of the social interface as the route end position. A point may be selected in various manners in a left-side region of the social interface as the route start position, and a point is selected in various manners in a right-side region of the social interface as the route end position.

The route generation rule may be a rule indicating that a generated route is a smooth curve, and routes generated according to the route generation rule are all smooth routes. According to the route generation rule, one or more routes may be generated between the route start position and the route end position. Different routes have different distances or shapes. When a plurality of routes is generated between the route start position and the route end position according to the route generation rule, the routes share one route start position and one route end position. The preset route along which the second virtual character travels to chase the first virtual character may be one route randomly generated from the generated routes. In this way, the flexibility of traveling routes used by virtual characters can be improved by providing a plurality of routes, and route reference and selection possibility may be provided for changing a traveling route of any virtual character in a chasing process of virtual characters. For example, the first route and the second route described above may be selected from one or more generated routes. In a feasible manner, the preset route is a smooth curve, and a bending degree of the curve is represented by a curvature. When the curvature is larger, the bending degree is larger. A standard traveling speed of the first virtual character is related to the curvature of the preset route. When the first virtual character travels to a corresponding position of the preset route, the standard traveling speed may be determined based on a curvature corresponding to the position, and the standard traveling speed may increase as the curvature increases.

In an embodiment, the first virtual character carries a virtual resource package, and before the playing of the first animation is stopped, the method may further include the following content: when the second virtual character reaches the first virtual character along the preset route, stopping playing the first animation, and displaying the virtual resource package in the social interface; or when the first virtual character finishes traveling the preset route earlier than the second virtual character, displaying the virtual resource package in the social interface, and stopping playing the first animation after the second virtual character finishes traveling the preset route.

When the second virtual character reaches the first virtual character along the preset route, the distance between the two virtual characters is zero or is less than the distance threshold. In this case, the playing of the chasing animation of the two virtual characters may be stopped. The virtual resource package displayed in the social interface is a virtual resource package carried by the first virtual character, and may be displayed with an increased size in the social interface. In another manner, an animation of the virtual resource package being knocked off may be executed in the social interface, or the virtual resource package may be not displayed in the social interface, and the playing of the first animation is stopped.

When the first virtual character finishes traveling the preset route earlier than the second virtual character, the first virtual character may be concealed in the social interface, and the virtual resource package may be displayed in the social interface. If the second virtual character is still chasing the first virtual character when the first virtual character finishes traveling, in other words, the second virtual character has not finished traveling the preset route, and the first animation is still not over, the playing of the first animation may be stopped after the second virtual character finishes traveling the preset route.

For example, FIG. 7B is a schematic diagram of displaying a virtual resource package. A first animation includes a first virtual character 7201 and a second virtual character 7202, and the first virtual character 7201 finishes traveling the preset route earlier than the second virtual character 7202. The first virtual character 7201 gradually disappears in a social interface 7203, the second virtual character 7202 still travels along a preset route, and a gift bag 7204 (i.e., a virtual resource package including a virtual resource) is still displayed in the social interface 7203.

The virtual resource may be applied to the social interface. In actual application, the virtual resource may be a virtual item, an experience point, game merchandise, or the like.

In another example, FIG. 7C is a schematic diagram of displaying a virtual resource package. As shown in (1) in FIG. 7C, a first animation includes a first virtual character 7301 and a second virtual character 7302. The second virtual character 7301 is about to reach the first virtual character 7302 along a preset route. In this case, a virtual resource package 7303 may be displayed in a social interface, the first virtual character speeds up to run out of the social interface, and the second virtual character continues to chase along.

In a feasible manner, the virtual resource package displayed in the social interface supports triggering within a preset display duration. When the preset display duration is reached, the virtual resource package may be concealed in the social interface, in other words, the display of the virtual resource package is canceled, to avoid affecting display of other content in the social interface. For example, the first virtual character finishes traveling the preset route, the virtual resource package may be displayed, and the virtual resource package may disappear within 2.5 seconds. For a virtual resource package shown in FIG. 7D, a first animation element included in a first animation does not exist in a social interface 7401, only a virtual resource package 7402 is displayed, and the virtual resource package may disappear from the social interface 7401 if the virtual resource package is not tapped within a particular duration.

In some embodiments, after the virtual resource package is displayed in the social interface, the method may further include the content shown in (1) and (2) below.

(1) Prompt information is outputted in response to display of the virtual resource package.

When the virtual resource package is displayed in the social interface, a client may automatically output prompt information, the prompt information being configured for prompting to collect the virtual resource package. An output manner of the prompt information including one or more of the following: a vibration manner, a speech manner, a text manner, and an image manner. When the output manner of the prompt information is a text manner or an image manner, the prompt information may be outputted in the social interface. When the output manner of the prompt information is a speech or vibration manner, such a prompt may be considered as a physical prompt. A terminal device may vibrate or output a voice, to make a more intense prompt to collect the virtual resource package. The vibration of the terminal device may be continuous vibrations or a single vibration.

For example, FIG. 7E is a schematic diagram of outputting prompt information. A social interface 7501 includes a virtual resource package 7502, and a text prompt 7503 “There is a gift bag to be collected. Collect as soon as possible.” is displayed in the social interface. A virtual resource gift bag may be collected by tapping the prompt information 7503 or tapping the virtual resource package 7502.

In an implementation, a social interface is displayed on a client, an animation rendering engine is built in the client, and the animation rendering engine is configured to render an animation; and the outputting prompt information in response to display of the virtual resource package includes: receiving an event notification message transmitted by the animation rendering engine; and outputting the prompt information in response to the event notification message.

The event notification message is transmitted when an event that the virtual resource package appears in the first animation is acquired in a process of rendering and displaying the first animation by the animation rendering engine. An event that a virtual resource package appears in the first animation is an event that a virtual resource package is displayed in the social interface before the playing of the first animation is stopped. Because the virtual resource package is rendered by the animation rendering engine and displayed in an interface of the social chat, the animation rendering engine may transmit an event notification message indicating that the virtual resource package appears. After receiving the event notification message, the client may output prompt information in response to the event notification message. The prompt information is, for example, a vibration prompt generated after the client performs vibration behavior.

(2) A resource collection interface is displayed when the virtual resource package is triggered.

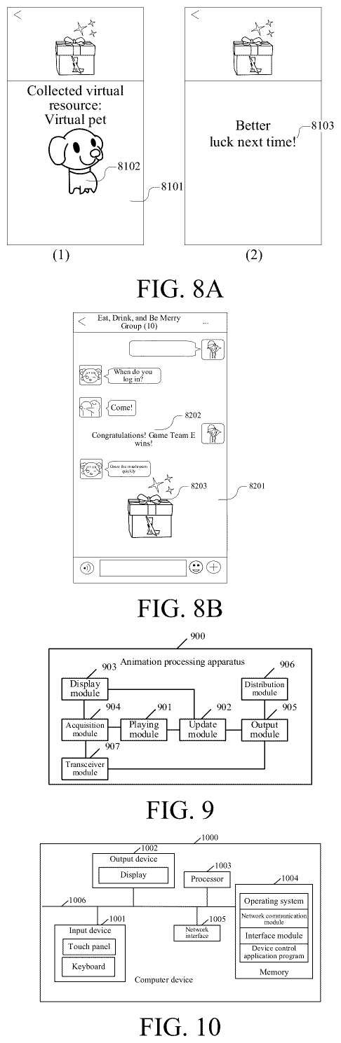

Any object may initiate a resource collection operation. For example, the virtual resource package displayed in the social interface may be triggered by tapping the virtual resource package, to further display the resource collection interface. The resource collection interface is configured to display a virtual resource and a virtual resource collection result. The virtual resource includes, but is not limited to, a virtual item, a virtual person, a game resource, and a real object jointly signed with a game. The virtual resource collection result is configured for indicating to collect virtual resources of a corresponding quantity, or no virtual resource is received. For example, FIG. 8A is a schematic diagram of a resource collection interface. As shown in (1) in FIG. 8A, a collection result for a virtual resource in a virtual resource package is displayed in a resource collection interface 8101, and a collected virtual pet 8102 is specifically displayed. As shown in (2) in FIG. 8A, a collection result displayed in a resource collection interface is text prompt information 8103: “Better luck next time!”

To improve the interactivity with a first animation, the virtual resource package carried by the first virtual character also supports triggering at any moment in the process of playing the first animation, and the resource collection interface is displayed.

In an embodiment, a social interface is displayed on a client, an animation rendering engine and an interface view are built in the client, the animation rendering engine is configured to render an animation, and the interface view is configured for displaying an interface in the client; and the displaying a resource collection interface when the virtual resource package is triggered includes: invoking the animation rendering engine to acquire a trigger position for the virtual resource package, and transmitting the trigger position to the interface view; and invoking the interface view to render and display the resource collection interface based on the trigger position.

The animation rendering engine may render various animations displayed on the social interface, the various animations including, but not limited to, the first animation, the second animation, and an animation displaying a virtual resource. The interface view may be configured for displaying a social interface in the client. The interface view is, for example, a chat view, and may display a chat interface of a social chat. The client may invoke the animation rendering engine to obtain the trigger position for the virtual resource package. For example, a position of the virtual resource package is tapped, and then the trigger position is transmitted to the interface view. The interface view may display the resource collection interface based on the trigger position. The resource collection interface may be a new interface independent of the social interface, or may be a floating window in the social interface. As can be learned, the interface view (for example, a chat view) is used to trigger the virtual resource package to display the resource collection interface. The interface view is informed of the trigger position for the virtual resource package by the animation rendering engine, and the interface view makes a response. The animation rendering engine and the interface view have clear division of work, and a display coupling degree between an interface and an animation is low, thereby facilitating flexible setting and adjustment.

In an embodiment, the social interface includes a chat interface of a social chat, the social chat includes a plurality of chat objects, and the plurality of chat objects are grouped into a first game group and a second game group; the message containing the key content is sent by at least one chat object; and the first game group corresponds to the first virtual character, and the second game group corresponds to the second virtual character.

The social chat includes at least two chat objects. If the social chat is a one-to-one chat, the social chat includes two chat objects. If the social chat is a group chat, the social chat includes more than two chat objects. The chat interface of the social chat may display a chat message sent by any chat object in the social chat. The plurality of chat objects may be grouped into different game groups. The first game group may include at least one chat object, and the second game group includes at least one chat object. For example, the social chat includes 10 chat objects. Each of the two game groups may include five chat objects. Different game groups may correspond to different virtual characters. The first virtual character may represent the first game group, and the second virtual character may represent the second game group. Any message containing key content existing in the social interface may be sent by a chat object in the first game group or a chat object in the second game group. A chat object in any game group sends a message containing the key content in the social interface. The second animation element in the second animation associated with the key content may act on the first virtual character or the second virtual character to change the distance between the first virtual character and the second virtual character. The social interface may include a message containing the key content sent by a chat object in the first game group and a message containing the key content sent by a chat object in the second game group. Consecutive messages containing the key content in the social chat may trigger different animations, so that the interactivity can be improved.

In a manner, if the second virtual character reaches the first virtual character on the preset route, a notification indicating that the second game group wins is outputted; and if the first virtual character finishes traveling the preset route earlier than the second virtual character, a notification indicating that the first game group wins is outputted.

In some embodiments, if the second virtual character reaches the first virtual character on the preset route, the distance between the second virtual character and the first virtual character is zero or less than a preset threshold. Because the second virtual character may represent the second game group, the notification indicating that the second game group wins may be outputted. Similarly, if the first virtual character finishes traveling the preset route earlier than the second virtual character, the second virtual character does to reach the first virtual character, it may be considered that the first game group wins, and the notification indicating that the first game group wins may be outputted. An output manner of a notification indicating that any game group wins includes, but is not limited to, a text manner, a speech manner, an image manner, and a vibration manner. If the social chat is a one-to-one chat, the first game group includes a first chat object, the second game group includes a second chat object, and an eventually outputted notification indicating that a game group wins is a notification indicating that one of the chat objects wins. In a feasible manner, a notification of winning may be outputted in a chat interface on a side of a chat object in a game group that wins, and a notification of losing may be outputted in a chat interface on a side of a chat object in a game group that loses. In another manner, the notification indicating that any game group wins may be outputted in the chat interfaces of the chat objects of the social chat without distinguishing game groups to which the chat objects belong.

For example, FIG. 8B shows a notification indicating that the second game group wins. A social chat is a group chat. A social interface is a chat interface of the social chat. A game team E formed by chat objects U1, U2, and U3 has won, a text prompt 8202 “Congratulations! Game Team E wins!” is outputted in a chat interface 8201 of any chat object, and a virtual resource package 8203 may be displayed. Further, an animation effect of a firework going off is played in the chat interface.

The first animation effect that the first animation element has may be changed in a message containing key content sent by a chat object. The chat message sent by the chat object may interact with the first animation to play a game in a manner of virtual characters chasing each other, so that the fun of social interaction is improved.

In some implementations, chat objects in a game group that wins may collect a virtual resource in a virtual resource package. For example, the virtual resource package may be displayed on sides of the chat objects of the social chat, and is only valid for a chat object that wins. Alternatively, the virtual resource package may be displayed only on sides of chat objects in a game group that wins, and is not displayed on sides of chat objects in a game group that has not won. Based on the displaying of the virtual resource package, the method may further include the following content: distributing virtual resources in the virtual resource package to chat objects in a game group that has won. For example, the game group that wins is the first game group or the second game group. The virtual resource package may be a virtual resource package carried by the first virtual character. The virtual resource in the virtual resource package may be randomly specified by an operator of the first animation, or may be determined through negotiation between the two game groups, or may be set by any game group. This is not limited in this disclosure. The virtual resource includes any of the following: a virtual item, a virtual decoration, and a virtual game resource. The virtual item is, for example, a walking stick, a bicycle, or a book. The virtual decoration is, for example, a virtual dress, virtual trousers, or virtual wings. The virtual game resource may be configured for exchanging an item, a decoration, or the like in the game.

The virtual resources in the virtual resource package may be evenly divided for chat objects in a game group that wins, or may be distributed based on contributions (for example, a frequency of sending a message containing key content, or a gain sum added to a virtual character) made by chat objects in a game group the wins for winning, and a chat object with a greater contribution may get more virtual resources. Alternatively, the virtual resources may be randomly distributed to the chat objects. In a manner, the virtual resources distributed to the chat objects may be automatically transferred into accounts of the chat objects, or may be actively collected and confirmed by the chat objects before being transferred into the accounts of the chat objects.

In an embodiment, the first animation element includes the first virtual character and the second virtual character, and the first animation effect of the first animation element in the first animation includes: a first distance exists between the second virtual character and the first virtual character, and the second virtual character chases the first virtual character along a preset route. Based on this, the method may further include content described in S604 below:

S604: In a process of playing the first animation, if a message containing key content does not appear in the social interface, update a first distance. For example, the first distance is updated when no message containing the key content appears in the view interface during the playback of the first animation. In an example, a movement speed of the second virtual character is updated based on the updated first distance.

A message containing key content does not appear in the social interface, and the second animation is not played in the social interface. Therefore, no intervention of another animation element exists in the process of playing the first animation. To make the first animation more vivid and fun, the first distance between the first virtual character and the second virtual character may be updated according to a preset update rule. Each of the first virtual character and the second virtual character has a traveling speed. The traveling speed of the first virtual character may depend on a curvature of the preset route, and the traveling speed of the second virtual character depends on the first distance. For example, when the distance between the two virtual characters exceeds the distance threshold, the traveling speed of the second virtual character may be increased. In this way, the traveling speed of the second virtual character is updated as the first distance is updated.

In a manner, the preset update rule includes: in a first distance phase of the preset route, the first distance is set to any value in a specified distance interval within every preset duration; in a second distance phase of the preset route, a target distance is randomly set to zero or set to any value in the specified distance interval based on a probability within every preset duration.

The first distance phase may be a preset route length of the preset route. For example, the first distance phase is the first ¾ route of the preset route. The preset duration is, for example, 0.2 seconds, or 1 second. The specified distance interval includes a distance value upper limit and a distance value lower limit. The specified distance interval is related to a distance of the preset route. For example, the distance of the preset route is x. The specified distance interval may be [0.02x, 0.1x]. If x is 10, the endpoints are respectively 0.2 and 1. The first distance may be specifically set to a value every preset duration, and the set value is a distance applied within a next preset duration. For example, a value may be taken from [0.2, 1] every 0.2 seconds and used as the distance between the first virtual character and the second virtual character after 0.2 seconds. For example, the value set at the 1.2^{nd} second is the distance between the two virtual characters at the 1.4th second. Through such a setting, in the first distance phase, a certain distance is always kept between the second virtual character and the first virtual character. The second virtual character does not reach the first virtual character. In the remaining distance (i.e., the second distance phase) of the preset route, the first distance may be selected from the specified distance interval or directly set to zero. Each of the two types of values has a corresponding probability. For example, in every 0.2 seconds, the first distance is set to 0 with a probability of 50%, and is randomly taken from [0.2, 1] with a probability of 50%. In this way, in the last section of distance, the second virtual character reaches the first virtual character with a probability of 50%.

In a manner, the first animation is subject to no intervention of another animation element. In a process of automatically executing the first animation, if the second virtual character reaches the first virtual character, the first virtual character and an animation (for example, an animation of the first virtual character being knocked off) associated with a virtual resource package carried in the first virtual character may be executed, and the playing of the first animation is stopped. If the second virtual character does not reach the first virtual character, an animation of the first virtual character placing the virtual resource package may be played, and the first virtual character is concealed in the social interface. Meanwhile, the second virtual character may speed up along the preset route and is eventually concealed in the animation in the social interface, and the playing of the first animation is stopped.

The first distance between the two virtual characters is updated according to the preset update rule. In an early phase (i.e., the first distance phase), the progress of the second virtual character chasing the first virtual character may be controlled within a certain range. In a later phase (i.e., the second distance phase), it may be randomly set with a probability that the second virtual character reaches the first virtual character or the second virtual character does not reach the first virtual character. With such randomness, an execution result of the first animation can be variable, thereby providing flexibility and more fun.

Next, related descriptions of an animation processing apparatus provided in embodiments of this disclosure are provided below.

FIG. 9 is a schematic structural diagram of an animation processing apparatus according to an embodiment of this disclosure. The animation processing apparatus may be a computer program (including program code) run on a computer device (the terminal device in the animation processing system shown in FIG. 1). For example, the animation processing apparatus is application software, and the animation processing apparatus may be configured to perform the corresponding operations in the animation processing method provided in the embodiments of this disclosure. As shown in FIG. 9, the animation processing apparatus 900 includes a playing module 901, an update module 902, a display module 903, an obtaining module 904, an output module 905, a distribution module 906, and a transceiver module 907.

The playing module 901 is configured to play a first animation in a social interface, the first animation including a first animation element, the first animation element having a first animation effect in the first animation.

The playing module 901 is configured to: in a process of playing the first animation, if a message containing key content appears in the social interface, play a second animation related to the key content in the social interface, the second animation including a second animation element.

The update module 902 is configured to update the first animation when the second animation element acts on the first animation element, the first animation element having a second animation effect in an updated first animation.

In an embodiment, the display module 903 is configured to display the social interface; and the playing module 901 is configured to: when a message containing target content exists in the social interface, play a first animation related to the target content in the social interface, the target content including at least one of the following: an identifier of the first animation, an identifier of the first animation element included in the first animation, an identifier of a source game of the first animation, and content associated with the first animation, a display form of the target content in the message containing the target content including at least one of the following: a text, an emoji, an image, and a speech.

In an embodiment, the key content includes at least one of the following: an identifier of the second animation, an identifier of the second animation element included in the second animation, an identifier of a source game of the second animation, and content associated with the second animation; a display form of the key content in the message containing the key content includes at least one of the following: a text, an emoji, an image, and a speech; and the second animation element acts on the first animation element, including any one of the following: a display position of the second animation element and a display position of the first animation element overlap; a distance between the display position of the second animation element and the display position of the first animation element is less than a preset distance threshold; a traveling direction of the second animation element is toward the first animation element; and the traveling direction of the second animation element is toward the first animation element, and the distance between the display position of the second animation element and the display position of the first animation element is less than the preset distance threshold.

The first animation element includes a first virtual character, and the first animation effect of the first virtual character in the first animation includes traveling according to a first speed; the second animation element includes an animation element configured for indicating to adjust a speed; and the update module 902 is configured to: when the second animation element acts on the first virtual character, change a traveling speed of the first virtual character according to the indication of the second animation element to update the first animation, the second animation effect of the first virtual character in the updated first animation including: traveling according to a second speed, if the second animation element indicates acceleration, the second speed being greater than the first speed, if the first animation element indicates deceleration, the second speed being less than the first speed.

In an embodiment, the first animation element includes a first virtual character, and the first animation effect of the first virtual character in the first animation includes traveling along a first route; the second animation element includes an animation element configured for indicating to adjust a route; and the update module 902 is configured to: when the second animation element acts on the first virtual character, updating the first animation by changing a traveling route of the first virtual character according to the indication of the second animation element, the second animation effect of the first virtual character in the updated first animation including traveling along a second route, the first route being different from the second route.

In an embodiment, the first animation element includes a first virtual character, and the first animation effect of the first virtual character in the first animation includes traveling according to a first direction; the second animation element includes an animation element configured for indicating to adjust a direction; and the update module 902 is configured to: when the second animation element acts on the first virtual character, update the first animation by changing a traveling direction of the first virtual character according to the indication of the second animation element, the second animation effect of the first virtual character in the updated first animation including traveling according to a second direction, the first direction being different from the second direction.

In an embodiment, the first animation element includes a first virtual character, and the first animation effect of the first virtual character in the first animation includes displaying in a first display manner; the second animation includes an animation element configured for indicating to adjust a display manner; and the update module 902 is configured to: when the second animation element acts on the first virtual character, update the first animation by changing a display manner of the first virtual character, the second animation effect of the first virtual character in the updated first animation including displaying in a second display manner, the first display manner being different from the second display manner, the display manner including any one of the following: displaying with an increased size, displaying with a reduced size, displaying a specific emoji, and displaying a designated action.

In an embodiment, the obtaining module 904 is configured to acquire a display position of the message containing the key content in the social interface; and the playing module 901 is configured to play the second animation related to the key content, the display position of the message containing the key content in the social interface being used as a display start position of the second animation element in the second animation.

In an embodiment, the first animation element includes a first virtual character and a second virtual character, and the first animation effect of the first animation element in the first animation includes: a first distance exists between the second virtual character and the first virtual character, and the second virtual character chases the first virtual character along a preset route; and the update module 902 is configured to: when the second animation element acts on the first virtual character or the second virtual character, update the first animation by changing a distance between the first virtual character and the second virtual character, the second animation effect of the first animation element in the updated first animation including: a second distance exists between the second virtual character and the first virtual character, and the second virtual character chases the first virtual character.

In an embodiment, the second virtual character chases the first virtual character along a preset route; and the first virtual character carries a virtual resource package, and the display module 903 is configured to: when the second virtual character reaches the first virtual character along the preset route, stop playing the first animation, and display the virtual resource package in the social interface; or when the first virtual character finishes traveling the preset route earlier than the second virtual character, display the virtual resource package in the social interface, and stop playing the first animation after the second virtual character finishes traveling the preset route.

In an embodiment, the social interface includes a chat interface of a social chat, the social chat includes a plurality of chat objects, and the plurality of chat objects are grouped into a first game group and a second game group; the message containing the key content is sent by at least one chat object; the first game group corresponds to the first virtual character, and the second game group corresponds to the second virtual character; and the output module 905 is configured to: if the second virtual character reaches the first virtual character on the preset route, output a notification indicating that the second game group wins; and if the first virtual character finishes traveling the preset route earlier than the second virtual character, output a notification indicating that the first game group wins.

In an embodiment, the distribution module 906 is configured to distribute virtual resources in the virtual resource package to chat objects in a game group that has won, the virtual resources including any one of the following: a virtual item, a virtual decoration, and a virtual game resource.

In an embodiment, the output module 905 is configured to output prompt information in response to display of the virtual resource package, the prompt information being configured for prompting to collect the virtual resource package; and the display module 903 is configured to display a resource collection interface when the virtual resource package is triggered.

In an embodiment, the social interface is displayed on a client, an animation rendering engine is built in the client, and the animation rendering engine is configured to render an animation; the transceiver module 907 is configured to receive an event notification message transmitted by the animation rendering engine, the event notification message being transmitted when an event that the virtual resource package appears in the first animation is acquired in a process of rendering and displaying the first animation by the animation rendering engine; and the output module 905 is configured to output the prompt information in response to the event notification message, an output manner of the prompt information including one or more of the following: a vibration manner, a speech manner, a text manner, and an image manner.

In an embodiment, the social interface is displayed on a client, an animation rendering engine and an interface view are built in the client, the animation rendering engine is configured to render an animation, and the interface view is configured for displaying an interface in the client; the transceiver module 907 is configured to: invoke the animation rendering engine to acquire a trigger position for the virtual resource package, and transmit the trigger position to the interface view; and the display module 903 is configured to invoke the interface view to render and display the resource collection interface based on the trigger position.

In an embodiment, an animation rendering engine is built in the client; the transceiver module 907 is configured to transmit the display position of the message containing the key content in the social interface to the animation rendering engine; and the playing module 901 is configured to: invoke the animation rendering engine to play the second animation, and render the second animation element by using the display position of the message containing the key content in the social interface as the display start position in a process of playing the second animation.

In an embodiment, the second virtual character chases the first virtual character along a preset route; and a manner of determining the preset route includes: determining a route start position and a route end position in the social interface; generating one or more routes according to a route generation rule, different routes having the same route start position and route end position; and selecting one route from the one or more routes as the preset route.

In an embodiment, the first animation element includes a first virtual character and a second virtual character, and the first animation effect of the first animation element in the first animation includes: a first distance exists between the second virtual character and the first virtual character, and the second virtual character chases the first virtual character along a preset route; and the update module 902 is further configured to: in a process of playing the first animation, if a message containing key content does not appear in the social interface, update the first distance according to a preset update rule, a traveling speed of the second virtual character being updated as the first distance is updated, the preset update rule including: in a first distance phase of the preset route, the first distance is set to any value in a specified distance interval within every preset duration; in a second distance phase of the preset route, a target distance is randomly set to zero or set to any value in the specified distance interval based on a probability within every preset duration.

The functions of the functional modules of the animation processing apparatus described in the embodiments of this disclosure may be implemented according to the methods in the embodiments of this disclosure. For an implementation process of the apparatus, refer to the related descriptions of the method embodiments. Details are not described herein again. In addition, the descriptions of beneficial effects of the same method are not described herein again.

Next, the related descriptions of a computer device provided in embodiments of this disclosure are provided below.

In an embodiment, the computer device may be a terminal device in the animation processing system shown in FIG. 1. FIG. 10 is a schematic structural diagram of a computer device according to an embodiment of this disclosure. As shown in FIG. 10, the computer device 1000 may specifically include an input device 1001, an output device 1002, a processor 1003 (e.g., processing circuitry), a memory 1004 (e.g., a non-transitory computer-readable storage medium), a network interface 1005, and at least one communication bus 1006. The processor 1003 may be a central processing unit (CPU). The processor may further include a hardware chip. The hardware chip may be an application-specific integrated circuit (ASIC), a programmable logic device (PLD), or the like. The PLD may be a field-programmable gate array (FPGA), a generic array logic (GAL), or the like.

The memory 1004 may include a volatile memory, for example, a random-access memory (RAM). The memory 1004 may alternatively include a non-volatile memory, for example, a flash memory or a solid-state drive (SSD). The memory 1004 may be a high-speed RAM memory, or may be a non-volatile memory, for example, at least one disk memory. In some embodiments, the memory 1004 may further be at least one storage apparatus that is located far away from the processor 1003. The memory 1004 may be a combination of the foregoing types of memories. As shown in FIG. 10, the memory 1004, which is used as a computer-readable storage medium, may include an operating system, a network communications module, an interface module, and a device control application program.

The network interface 1005 may include a standard wired interface and a standard wireless interface (for example, a Wi-Fi interface). The network interface is used as a communication interface, and may be configured to provide a data communication function. The communication bus 1006 is responsible for connecting various communication components. The input device 1001 receives an instruction entered by an object to generate a signal input related to an object setting and function control of the computer device. In an embodiment, the input device 1001 includes, but is not limited to, one or more of a touch panel, a physical keyboard or a virtual keyboard, a function key, a mouse, and the like. The output device 1002 is configured to output data information. The output device 1002 in the embodiments of this disclosure may be configured to display a social interface, play an animation, output a prompt, and the like. The output device 1002 may include a display or another display device. The processor 1003 is a control center of the computer device, and is connected to various parts of the entire computer device through various interfaces and lines. A computer program stored in the memory 1004 is scheduled and run to perform various functions.

The processor 1003 may be configured to invoke the computer program in the memory 1004 to perform the following operations: playing a first animation in the social interface through the output device 1002, the first animation including a first animation element, the first animation element having a first animation effect in the first animation; in a process of playing the first animation, if a message containing key content appears in the social interface, playing a second animation related to the key content in the social interface, the second animation including a second animation element; and updating the first animation when the second animation element acts on the first animation element, the first animation element having a second animation effect in an updated first animation.

The computer device 1000 described in this embodiment of this disclosure may implement the descriptions of the animation processing method in the foregoing corresponding embodiments, or the descriptions of the animation processing apparatus 900 in the foregoing embodiment corresponding to FIG. 9. Details are not described herein again. In addition, the descriptions of beneficial effects of the same method are not described herein again.

In addition, an embodiment of this disclosure further provides a storage medium. The storage medium has a computer program of the foregoing animation processing method stored therein. The computer program includes computer instructions. The computer instructions, when loaded and executed by one or more processors, may implement the descriptions of the animation processing method in the embodiments. Details are not described herein again. The descriptions of beneficial effects of the same method are not described herein again. The computer instructions may be deployed on one computer device or a plurality of computer devices that can communicate with each other for execution.

The foregoing computer-readable storage medium may be the animation processing apparatus provided in any foregoing embodiment or an internal storage unit of the computer device, for example, a hard disk drive or internal memory of the computer device. The computer-readable storage medium may be an external storage device of the computer device, for example, a removable hard disk drive, a smart media card (SMC), a secure digital (SD) card, or a flash card equipped on the computer device. Further, the computer-readable storage medium may include both an internal storage unit of the computer device and an external storage device. The computer-readable storage medium is configured to store the computer program and another program and data that are required by the computer device. The computer-readable storage medium may be further configured to temporarily store data that has been outputted or data to be outputted.

Embodiments of this disclosure provide a computer program product or a computer program, the computer program product or the computer program including computer instructions, the computer instructions being stored in a computer-readable storage medium such as a non-transitory computer-readable storage medium. A processor of a computer device reads the computer instructions from the computer-readable storage medium, and the processor executes the computer instructions, to cause the computer device to perform the method provided in the embodiments of this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The operations in the method in the embodiments of this disclosure may be adjusted in sequence, combined or deleted according to an actual requirement. The modules in the apparatus in the embodiments of this disclosure may be combined, grouped or deleted according to an actual requirement.

The foregoing disclosure is some embodiments of this disclosure, and certainly is not intended to limit the protection scope of this disclosure. A person of ordinary skill in the art may understand that all or some of the processes in the foregoing embodiments, and make equivalent variations in accordance with the claims of this disclosure shall fall within the scope of the present disclosure.

What is claimed is:

1. An animation processing method, comprising:
displaying a first animation in a view interface, the first animation including a first animation element having a first animation effect in the first animation;
when a message that contains key content is displayed in the view interface during playback of the first animation, displaying a second animation associated with the key content in the view interface, the second animation including a second animation element; and
updating the first animation when the second animation element interacts with the first animation element, the first animation element having a second animation effect in the updated first animation.

2. The method according to claim 1, wherein the displaying the first animation in the view interface comprises:
when a message that contains target content is displayed in the view interface, displaying the first animation in the view interface, the target content including at least one of:
an identifier of the first animation, an identifier of the first animation element, a source identifier of the first animation, or content associated with the first animation.

3. The method according to claim 1, wherein
the interaction between the second animation element and the first animation element is determined based on at least one of:
a display position of the second animation element at least partially overlapping with a display position of the first animation element;
a distance between the display position of the second animation element and the display position of the first animation element being less than a distance threshold;
a movement direction of the second animation element being toward the first animation element;
the movement direction of the second animation element being toward the first animation element; and
the distance between the display position of the second animation element and the display position of the first animation element being less than the distance threshold.

4. The method according to claim 1, wherein the first animation element includes a first virtual character having the first animation effect of moving at a first movement speed, the second animation element is configured to adjust a movement speed of the first virtual character, and
the updating the first animation comprises:
changing the movement speed of the first virtual character from the first movement speed to a second movement speed when the second animation element interacts with the first virtual character, the second animation effect including the first virtual character moving at the second movement speed,
wherein the second movement speed is greater than the first movement speed when the second animation element indicates acceleration, and the second movement speed is less than the first movement speed when the second animation element indicates deceleration.

5. The method according to claim 1, wherein the first animation element includes a first virtual character having the first animation effect of moving along a first path, and the second animation element is configured to adjust a movement path of the first virtual character, and
the updating the first animation comprises:
changing the movement path of the first virtual character from the first path to a second path when the second animation element interacts with the first virtual character, wherein
the second animation effect includes the first virtual character moving along the second path that is different from the first path.

6. The method according to claim 1, wherein the first animation element includes a first virtual character having the first animation effect of moving in a first direction, the second animation element is configured to adjust a movement direction of the first virtual character;
the updating the first animation includes changing the movement direction of the first virtual character from the first direction to a second direction when the second animation element interacts with the first virtual character; and
the second animation effect includes the first virtual character moving in the second direction that is different from the first direction.

7. The method according to claim 1, wherein the first animation element includes a first virtual character having the first animation effect of being displayed in a first display mode, the second animation element is configured to adjust a display mode of the first virtual character;
the updating the first animation includes changing the display mode of the first virtual character from the first display mode to a second display mode when the second animation element interacts with the first virtual character; and
the second animation effect includes the first virtual character being displayed in the second display mode that is different from the first display mode.

8. The method according to claim 1, wherein the displaying the second animation comprises:
determining a display position of the message containing the key content in the view interface; and
displaying the second animation using the display position as a start position for displaying the second animation element.

9. The method according to claim 1, wherein the first animation element includes a first virtual character and a second virtual character, the first animation effect includes the second virtual character chasing the first virtual character while maintaining a first distance between the second virtual character and the first virtual character, and the updating the first animation comprises:
modifying the first distance between the first virtual character and the second virtual character when the second animation element interacts with either the first virtual character or the second virtual character, wherein the second animation effect includes the second virtual character chasing the first virtual character while maintaining a second distance between the second virtual character and the first virtual character.

10. The method according to claim 9, wherein the second virtual character chases the first virtual character along a preset path, the first virtual character carries a virtual resource package, and the method further comprises:
stopping the first animation and displaying the virtual resource package in the view interface when the second virtual character reaches the first virtual character along the preset path; or
displaying the virtual resource package in the view interface when the first virtual character completes the preset path before the second virtual character and stopping the first animation after the second virtual character completes the preset path.

11. The method according to claim 10, wherein the view interface includes a chat interface having a plurality of chat objects grouped into a first game group and a second game group, the message containing the key content is sent by at least one chat object of the plurality of chat objects, the first game group corresponding to the first virtual character, the second game group corresponding to the second virtual character, and the method further comprises:
displaying a second victory notification indicating that the second game group is a winning group when the second virtual character reaches the first virtual character on the preset path; or
displaying a first victory notification indicating that the first game group is the winning group when the first virtual character completes the preset path before the second virtual character.

12. The method according to claim 11, further comprising:
distributing virtual resources from the virtual resource package to the winning group, the virtual resources including at least one of: virtual items, virtual decorations, and virtual game resources.

13. The method according to claim 10, further comprising:
displaying a collection notification when displaying the virtual resource package, the collection notification indicating the virtual resource package is available for collection; and
displaying a resource collection interface when a trigger operation for the virtual resource package is performed.

14. The method according to claim 13, wherein the view interface is displayed by a client having an animation rendering engine, and the displaying the collection notification comprises:
receiving an event notification from the animation rendering engine when the virtual resource package appears in the first animation during rendering; and
displaying the collection notification in response to the event notification.

15. The method according to claim 13, wherein the view interface is displayed by a client having an animation rendering engine and a display, and the displaying the resource collection interface comprises:
obtaining a trigger position for the virtual resource package though the animation rendering engine;
transmitting the trigger position to the display; and
rendering and displaying the resource collection interface at the trigger position through the display.

16. The method according to claim 8, wherein the view interface is displayed by a client having an animation rendering engine, and the displaying the second animation comprises:
transmitting the display position of the message containing the key content to the animation rendering engine; and
rendering the second animation element using the display position as the start position through the animation rendering engine.

17. The method according to claim 10, further comprising:
determining the preset path by:
determining a start position and an end position in the view interface;
generating at least one path having the determined start position and the determined end position; and
selecting a path from the at least one path as the preset path.

18. The method according to claim 1, wherein the first animation element includes a first virtual character and a second virtual character, the first animation effect includes the second virtual character chasing the first virtual character along a preset path while maintaining a first distance, and the method further comprises:
updating the first distance when no message containing the key content appears in the view interface during the playback of the first animation, a movement speed of the second virtual character being updated based on the updated first distance.

19. An apparatus, comprising:
processing circuitry configured to:
display a first animation in a view interface, the first animation including a first animation element having a first animation effect in the first animation;
when a message that contains key content is displayed in the view interface during playback of the first animation, display a second animation associated with the key content in the view interface, the second animation including a second animation element; and
update the first animation when the second animation element interacts with the first animation element, the first animation element having a second animation effect in the updated first animation.

20. A non-transitory computer-readable storage medium, storing instructions which when executed by a processor cause the processor to perform:
displaying a first animation in a view interface, the first animation including a first animation element having a first animation effect in the first animation;
when a message that contains key content is displayed in the view interface during playback of the first animation, displaying a second animation associated with the key content in the view interface, the second animation including a second animation element; and
updating the first animation when the second animation element interacts with the first animation element, the first animation element having a second animation effect in the updated first animation.
